(19) United States
(12) Patent Application Publication
(10) Pub. No.: US 2019/0001528 A1
(43) Pub. Date: Jan. 3, 2019

(54) EXTRUDER FOR PROCESSING POLYMER MELTS

(71) Applicant: BASF SE, Ludwigshafen am Rhein (DE)

(72) Inventor: Andreas LOHSE, Lemfoerde (DE)

(73) Assignee: BASF SE, Ludwigshafen am Rhein (DE)

(21) Appl. No.: 16/064,816

(22) PCT Filed: Dec. 12, 2016
(86) PCT No.: PCT/EP2016/080583

§ 371 Date: Jun. 21, 2018

(30) Foreign Application Priority Data
Dec. 22, 2015 (DE) 10 2015 226 557.9

(51) Int. Cl. B29B 9/06; B29B 7/72; B29B 7/38

(52) U.S. Cl. CPC B29B 9/065; B29B 7/38; B29B 7/72

(57) ABSTRACT

An extruder containing a housing having a flow channel for a melt and a perforated plate delimiting the flow channel on the outlet side, where the perforated plate has at least two through-flow areas spaced apart from one another, each through-flow area contains at least one through-flow opening, and the perforated plate is furthermore mounted in a changing device, where the changing device has guide elements, in which the perforated plate can be moved substantially perpendicularly to the flow channel, and the extruder, directly ahead of the perforated plate when viewed in the direction of flow of the melt, has an inlet flow cone, which is structurally separate from the perforated plate, thus allowing the through-flow areas of the perforated plate to be moved relative to the inlet flow cone.

The invention relates to an extruder comprising a housing having a flow channel for a melt and a perforated plate delimiting the flow channel on the outlet side.

Extruders and perforated plates of the type in question are known from the literature. Thus, document DE 35 32 937 A1 describes a perforated plate which is secured on the outlet end of an extruder and is suitable for underwater granulation of extruded plastics, for example.

In conventional production processes, e.g. those for producing plastic granules, heated material such as a polymer melt is passed through a flow channel in the housing of an extruder and forced through openings in the perforated plate at the outlet. As the process progresses, deposits and adhesions form in the openings of the perforated plate until finally the open cross sections have been reduced to such an extent that the perforated plate must be cleaned or exchanged. When cleaning in continuous operation, this is inevitably associated with a loss of material. When exchanging the perforated plate, the plant must be shut down, leading to down-times and associated losses of capacity.

In order to counteract the losses of material and capacity, filter screens that are inserted exchangeably within the extruder in the path of the flow ahead of the perforated plate are known. Thus, DE 30 13 038 A1 discloses a screen changing device for extruders for the continuous processing of melted plastics, in which a changeover slide that can be moved transversely to the flow channel for the melt is provided in a location hole in the extruder housing.

In DE 28 11 771 A1, a description is given of a filter screen changing device for a synthetic resin extruder, in which the flow path within the extruder is divided into two parallel subchannels. Before the outlet from the extruder, the two subchannels are reunited to form a single outlet channel. In each of the two subchannels there is a movable plate, half of which is of solid construction without apertures and the other half has a hole with an inserted filter screen. The plates are positioned in such a way that, during operation, one subchannel in each case is shut off by the solid part of a plate and the plastic melt flows through the filter screen situated in the other sub-channel. To clean the filter screens, the positions of the plates are reversed, so that the previously open channel is then closed and the melt then flows through the previously closed channel. The contaminated filter screen is then situated outside the extruder housing and can be exchanged or cleaned.

However, the measures described can only delay, not prevent, soiling and blockage of the perforated plate at the outlet from the extruder. Losses of material and downtimes are therefore merely reduced thereby.

The object was to develop an extruder of the type in question in such a way that production-related losses of material and downtimes are reduced to a minimum.

According to the invention, this object is achieved by an extruder comprising a housing having a flow channel for a melt and a perforated plate delimiting the flow channel on the outlet side, wherein the perforated plate has at least two through-flow areas spaced apart from one another, wherein each through-flow area contains at least one through-flow opening, and the perforated plate is furthermore mounted in a changing device, wherein the changing device has guide elements, in which the perforated plate can be moved substantially perpendicularly to the flow channel.

In the context of the invention, a perforated plate is taken to be the component out of which the melt leaves the extruder before it is fed to further processing. Filtering or screening devices that may optionally be present within the extruder are not “perforated plates” in the sense according to the invention.

The perforated plate according to the invention has at least two through-flow areas spaced apart from one another, wherein each through-flow area contains at least one through-flow opening. The through-flow openings can be configured differently, both in respect of their cross-sectional shape (e.g. round, oval, elongate or polygonal) and in respect of their dimensions. The through-flow openings can all have the same shape and dimensions, but they can also be configured differently. The shape and size of the through-flow area is determined by the through-flow openings which the through-flow area contains. In the case of a round through-flow area, for example, the through-flow openings are arranged in such a way that the envelope around all the through-flow openings of this through-flow area has a round shape.

The external contour (envelope) of the through-flow areas is preferably matched to the cross-sectional shape of the flow channel of the extruder, thus preferably allowing the melt flowing through the flow channel to impinge upon the entire through-flow area of the perforated plate.

In an advantageous embodiment, the through-flow openings comprise extrusion dies for the formation of plastic strands, which can then be processed with the aid of a tool, e.g. a cutter, to give granules.

The spacing between the through-flow areas is taken to be the shortest distance between two points on the envelopes of the respective through-flow areas. The spacing between the through-flow areas of the perforated plate is preferably dimensioned in such a way that, when one through-flow area is positioned at the outlet of the flow channel, at least one other through-flow area is situated outside the housing of the extruder. Such an embodiment has the advantage that the through-flow areas situated outside the housing can be cleaned or exchanged without problems without the need to interrupt the flow of melt for this purpose.

According to the invention, the perforated plate can be moved substantially perpendicularly to the flow channel. The angle formed between the axis of the flow channel and the plane of movement of the perforated plate is relevant. Movement which is substantially perpendicular in this sense has the advantage that the period of time during the movement in which the melt impinges upon a solid, impermeable region of the perforated plate is minimized.

In a preferred embodiment of the invention, the changing device with its guide elements is configured in such a way that the movement of the perforated plate is linear.

In another preferred embodiment of the invention, the changing device with its guide elements is configured in such a way that the movement of the perforated plate is accomplished by rotation of the perforated plate. In such an embodiment, it is preferred that the perforated plate have a multiplicity of through-flow areas, e.g. 3, 4, 5, 6 or even more through-flow areas, distributed over its circumference. The multiplicity of through-flow areas is preferably arranged in a manner distributed in rotational symmetry over the perforated plate. In this embodiment too, the arrangement of the through-flow areas and the spacings between them are chosen so that, when one through-flow area is positioned at the outlet of the flow channel, at least one other through-flow area is situated outside the housing of the extruder.

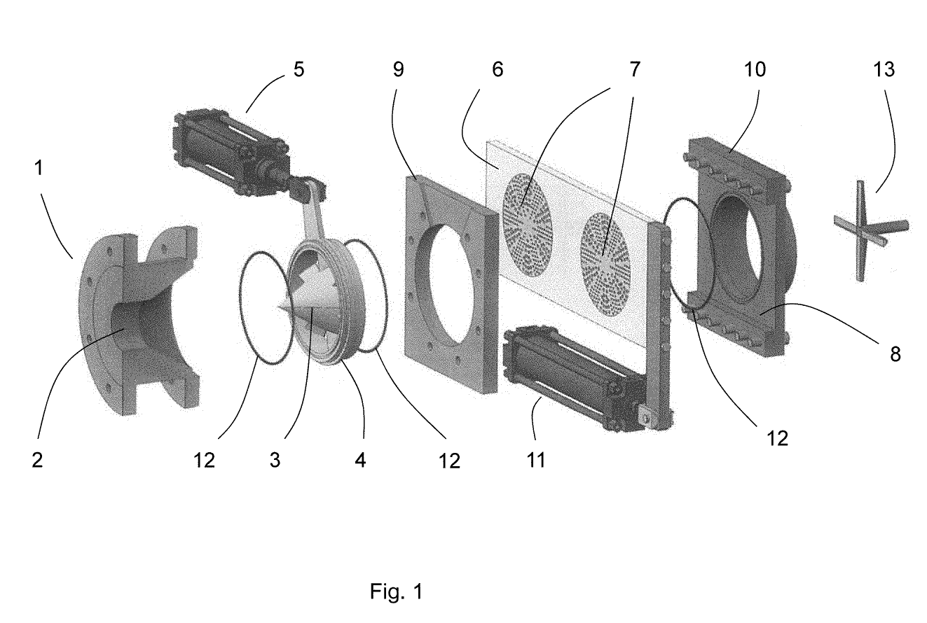

In the case of known perforated plates, an inlet flow cone is provided ahead of the perforated plate in the direction of flow of the melt, said cone being connected firmly to the perforated plate, as shown by way of example in FIG. 1 of German Laid-Open Application DE 35 32 937 A1. The perforated plate, in turn, is connected firmly to the end of the extruder housing. In an embodiment of this kind, movement of the perforated plate is not possible.

In an embodiment according to the invention, in which an inlet flow cone is situated directly ahead of the perforated plate when viewed in the direction of flow of the melt, this inlet flow cone is structurally separate from the perforated plate, thus allowing the through-flow areas of the perforated plate to be moved relative to the inlet flow cone. In this context, the term “cone” should not be taken in a strictly mathematical sense. In the sense according to the invention, the inlet flow cone can have the form of a cone, a truncated cone or some other shape that tapers counter to the direction of flow of the melt. In this case, the base can be circular or elliptical or polygonal, for example.

In a particularly advantageous development, the inlet flow cone is integrated into an inlet flow element which has passage areas and covering areas and is arranged so as to be movable in such a way that, when the inlet flow element is moved, a first subset of holes in the perforated plate is exposed and a second subset of holes in the perforated plate is closed. Corresponding inlet flow elements and the configuration thereof are described in detail in the parallel German patent application with the number 102015226512.9.

In an advantageous embodiment, the changing device has a plate which is first and a plate which is second when viewed in the direction of flow of the melt, both of which have an internal opening through which the melt can flow. In this embodiment, the first plate, the second plate or both plates has/have a recess, in which the perforated plate is movably mounted. The recess or recesses acts/act as guide elements in which the perforated plate can be moved substantially perpendicularly to the flow channel.

Sealing elements, which prevent partial quantities of the melt escaping between the plate and the perforated plate, are preferably arranged in the first plate and in the second plate on or in their respective side facing the perforated plate. Suitable materials and embodiments for the sealing elements are known to those skilled in the art, being based, for example, on graphite, silicones, elastomers or metals, such as copper.

In an advantageous development of the invention, the perforated plate, components of the changing device or perforated plate and components of the changing device are designed to be heatable, e.g. by inputting electrical energy or radiant heat.

The movement of the perforated plate in the changing device can be accomplished manually, optionally with the aid of tools such as levers. The movement is preferably accomplished using auxiliary power, e.g. electric, pneumatic or hydraulic auxiliary power. As a preferred option, the movement of the perforated plate is accomplished with the aid of an actuator.

In an advantageous embodiment, there is at least one sensor in or on the housing of the extruder, said sensor being suitable for detecting information on the pressure in the flow channel.

From the information on the pressure in the flow channel, it is possible to obtain information on the degree of blockage of the through-flow area that is in use.

In a preferred embodiment, this information is transmitted to an indicator by means of a device for electronic data transfer. The indicator can be in the immediate vicinity of the extruder in order, for example, to draw attention optically and/or acoustically to imminent blockage of the perforated disc, for example. However, the indicator can also be spatially remote from the extruder, e.g. in the form of an optically and/or acoustically perceptible indication in a process control system.

In a preferred embodiment, the extruder according to the invention has an actuator for moving the perforated plate, at least one sensor for detecting a pressure in the flow channel and a control module, wherein the control module is designed in such a way that the perforated plate is moved with the aid of the actuator when a predetermined critical value for the pressure or for a pressure difference is reached.

In an advantageous embodiment, the sensor is arranged and designed in such a way that the absolute pressure in the flow channel is determined. In another advantageous embodiment, at least two sensors are provided, which are arranged and designed in such a way that a pressure difference is determined. The predetermined critical value for the pressure or for the pressure difference is preferably matched to the respective melt being processed and to the corresponding process conditions. When detecting the absolute pressure as the critical value, it is thus possible, for example, to specify a pressure which is lower by a certain amount than the pressure at which safety devices, such as a safety valve or a shutdown valve, are triggered.

The control module can be implemented in a known manner, e.g. as a separate microcontroller, integrated into the actuator or as a module in a process control system.

With this embodiment, the process of changing the perforated plate can be very largely automated. In a preferred method, the following steps are carried out:
(1) Operating the extruder with a first through-flow area of the perforated plate at the outlet of the flow channel.
(2) Monitoring the pressure in the housing of the extruder.
(3) When a predetermined critical value for the pressure is reached, actuating the actuator and moving the perforated plate, with the result that a second, clean through-flow area is positioned at the outlet of the flow channel and the first through-flow area is situated out- side the extruder housing.
(4) Cleaning or exchanging the first through-flow area.
(5) Continuing the method at step (2), wherein the first and second through-flow area receive the flow and are cleaned alternately.

Compared with known apparatus, the apparatus according to the invention has the advantage that virtually fully continuous operation of the extruder can be ensured. In all cases, the availability of the plant is significantly increased, as a result of which capacity is boosted and loss of material is avoided.

The invention is explained in greater detail below with reference to the drawing. The drawing should be understood as a schematic illustration. It does not represent a restriction of the invention, in respect of specific dimensions or variant embodiments for example.

### LIST OF REFERENCE SIGNS USED

1 . . . extruder outlet
2 . . . flow channel
3 . . . inlet flow cone
4 . . . inlet flow element
5 . . . actuator for inlet flow element
6 . . . perforated plate
7 . . . through-flow area
8 . . . guide element
9 . . . first plate
10 . . . second plate
11 . . . actuator for changing device
12 . . . seal
13 . . . granulating tool

A preferred embodiment of the invention is reproduced schematically in exploded view in FIG. 1. Of the extruder, only the extruder outlet 1 is shown. The direction of flow of the melt is from left to right. A first plate 9 and a second plate 10 are flanged to the outlet end of the extruder and connected firmly to the extruder.

Between the upper and lower end, the second plate 10 has an internal recess 8, in which a perforated plate 6 is movably mounted. The perforated plate 6 comprises two through-flow areas 7, which both contain a multiplicity of through-flow openings. The outer contour of the through-flow areas 7 (envelope around the through-flow openings) is in each case circular and corresponds in cross section to the internal cross section of the flow channel 2 at this point. To move the perforated plate 6, an actuator 11 is provided, which can move the perforated plate substantially perpendicularly to the flow channel 2 by means of a linear motion.

Arranged between the extruder outlet 1 and the first plate 9 is an inlet flow element 4, which can be rotated through a predetermined angle with the aid of an actuator 5. For specific embodiments and advantages of this inlet flow element 4, attention is drawn to the parallel German Patent Application 102015226512.9.

To avoid the melt escaping at an unwanted location, sealing elements 12 are provided between the extruder outlet 1, the inlet flow cone 3, the perforated plate 6 and the second plate 10.

A granulating tool 13 is provided at the outlet end of the apparatus, resting on the perforated plate 6 and cutting the melt strands emerging through the through-flow openings into small granules by means of a rotary motion.

1. An extruder comprising a housing having a flow channel for a melt and a perforated plate delimiting the flow channel on the outlet side, wherein the perforated plate has at least two through-flow areas spaced apart from one another, wherein each through-flow area contains at least one through-flow opening, and the perforated plate is furthermore mounted in a changing device, wherein the changing device has guide elements, in which the perforated plate can be moved substantially perpendicularly to the flow channel,
and the extruder, directly ahead of the perforated plate, when viewed in the direction of the flow of the melt, has an inlet flow cone, which is structurally separate from the perforated plate, thus allowing the through-flow areas of the perforated plate to be moved relative to the inlet flow cone.

2. The extruder as claimed in claim 1, wherein the spacing between the through-flow areas of the perforated plate is dimensioned in such a way that, when one through-flow area is positioned at the outlet of the flow channel, at least one other through-flow area is situated outside the housing of the extruder.

3. (canceled).

4. The extruder as claimed in claim 1, wherein the changing device has a plate which is first and a plate which is second when viewed in the direction of flow of the melt, both of which have an internal opening through which the melt can flow, and wherein the first plate and/or the second plate have/has a recess, in which the perforated plate is movably mounted.

5. The extruder as claimed in claim 1, further comprising an actuator for moving the perforated plate, at least one sensor for detecting a pressure in the flow channel and a control module, wherein the control module is designed in such a way that the perforated plate is moved with the aid of the actuator when a predetermined critical value for the pressure or for a pressure difference is reached.
